(19) United States
(12) Patent Application Publication
(10) Pub. No.: US 2016/0016776 A1
(43) Pub. Date: Jan. 21, 2016

(54) WATER DISPENSER

(71) Applicant: KABUSHIKI KAISHA COSMO LIFE, Kakogawa-shi, Hyogo (JP)

(72) Inventor: Yoshinori ORITA, Hyogo (JP)

(73) Assignee: Kabushiki Kaisha Cosmo Life, Hyogo (JP)

(21) Appl. No.: 14/771,813

(22) PCT Filed: Dec. 13, 2013
(86) PCT No.: PCT/JP2013/083495

§ 371 Date: Sep. 1, 2015

(30) Foreign Application Priority Data
Mar. 5, 2013 (JP) 2013-042962

(51) Int. Cl. B67D 1/00; B67D 1/12; B67D 1/10; B67D 1/08; B67D 1/07

(52) U.S. Cl. CPC B67D 1/0009; B67D 1/0895; B67D 1/0857; B67D 1/07; B67D 1/10; B67D 1/1279; B67D 2001/075

(57) ABSTRACT

A water dispenser is provided which is hygienic and which enables a user to use low-temperature drinking water even during sterilization operation. The water dispenser includes a cold water tank, a raw water pumping pipe through which a raw water container communicates with the cold water tank, a pump provided at an intermediate portion of the raw water pumping pipe, a hot water tank, a buffer tank provided above the hot water tank, a hot water tank supply pipe through which the buffer tank communicates with the hot water tank, first and second three way valves provided in the raw water pumping pipe, a buffer tank supply pipe through which the first three-way valve communicates with the buffer tank, and a circulation pipe through which the second three-way valve communicates with the hot water tank.

### TECHNICAL FIELD

This invention relates to a water dispenser which is used to supply drinking water, such as mineral water, stored in a replaceable raw water container.

### BACKGROUND ART

While water dispensers were mainly used in offices and hospitals, with the growing interest in the safety of water and health, they are now being increasingly used in ordinary households too. Known water dispensers for use in ordinary households are typically configured such that a replaceable raw water container is set on the top surface of the housing so that drinking water filling the raw water container is dropped under gravity into a cold water tank mounted in the housing (as disclosed in the below-identified Patent document 1).

Since the water dispenser disclosed in Patent document 1 is configured such that the raw water container is set on the top surface of the housing, when replacing the raw water container with a new, completely filled one, it is necessary to lift the latter to a high level. A typical raw water container can hold up to about 10 to 12 liters, and thus, when completely filled with water, a typical raw water container weighs more than 10 kilograms. Replacement of such raw water containers is therefore hard and difficult for a user (especially a female and/or elderly user).

Therefore, the inventor of the present application considered a water dispenser of the type in which the raw water container can be set in the lower portion of the housing, whereby the raw water container can be easily replaced with a new one.

As shown in FIG. 17, such a water dispenser would include a cold water tank 50, a replaceable raw water container 51 in which is stored drinking water to be supplied into the cold water tank, a raw water pumping pipe 52 through which the raw water container 51 communicates with the cold water tank 50, a pump 53 provided at an intermediate portion of the raw water pumping pipe 52, a hot water tank 54 provided below the cold water tank 50, a tank connecting pipe 55 through which drinking water in the cold water tank 50 can be introduced under gravity into the hot water tank 54, and a heater 56 for heating the drinking water in the hot water tank 54. A baffle plate 57 is provided in the cold water tank 50 to divide the interior of the cold water tank 50 into upper and lower portions. The tank connecting pipe 55 is open at its top end to the center of the baffle plate 57.

By operating a cold water cock 58, low-temperature drinking water in the cold water tank 50 can be discharged to outside through a cold water discharge pipe 59 extending from the bottom surface of the cold water tank 50. At this time, the amount of the drinking water in the cold water tank 50 decreases. When, as a result, the water level in the cold water tank 50 falls below a predetermined water level, the pump 53 is activated, so that drinking water in the raw water container 51 is pumped up through the raw water pumping pipe 52 into the cold water tank 50. The baffle plate 57 prevents the low-temperature drinking water collected in the lower portion of the cold water tank 50 from being stirred by normal-temperature drinking water supplied from the raw water container 51, thus keeping drinking water discharged through the cold water discharge pipe 59 at low temperature.

By operating a hot water cock 60, high-temperature drinking water in the hot water tank 54 can be discharged to outside through a hot water discharge pipe 61 extending from the top surface of the hot water tank 54. At this time, drinking water in the portion of the cold water tank 50 over the baffle plate 57 is introduced under gravity into the hot water tank 54 through the tank connecting pipe 55. By supplying drinking water in the portion of the cold water tank 50 above the baffle plate 57, which is higher in temperature than the drinking water collected in the portion of the cold water tank 50 below the baffle plate 57, it is possible to minimize energy loss both in the cold water tank 50 and the hot water tank 54.

### PRIOR ART DOCUMENT(S)

### Patent Document(s)

Patent document 1: JP Patent Publication 2012-162318A

### SUMMARY OF THE INVENTION

### Object of the Invention

The inventor of the present application manufactured in-house a prototype of the water dispenser shown in FIG. 17, and discovered that this water dispenser still has room for improvement regarding its hygienic properties.

In particular, since low-temperature drinking water cooled in the cold water tank 50 is relatively high in specific gravity, it collects in the lower portion of the cold water tank 50. Since drinking water in the cold water tank 50 is divided into upper and lower portions by the baffle plate 57, heat is less likely to be transferred between the divided portions of water. It therefore takes a longer time to completely cool drinking water in the portion of the cold water tank 50 above the baffle plate 57, and thus this portion of water remains high in temperature. Since the cold water tank 50 and the hot water tank 54 are connected together through the tank connecting pipe 55, high-temperature drinking water in the hot water tank 54 could flow into the cold water tank 50 through the tank connecting pipe 55. This also tends to raise the temperature of the portion of drinking water in the cold water tank 50 above the baffle plate 57.

It was discovered that once the temperature of the drinking water in the portion of the interior of the cold water tank 50 above the baffle plate 57 rises, even if this portion of drinking water is cooled again to a low temperature, germs tend to proliferate in the cold water tank 50.

In order to prevent proliferation of germs in the cold water tank 50, the inventor of the present application considered sterilizing the interior of the cold water tank 50, using high-temperature drinking water in the hot water tank 54. However, this makes it impossible for a user to use low-temperature drinking water while the cold water tank 50 is being sterilized, which makes the water dispenser less convenient to use. Also, if, while the cold water tank 50 is being sterilized, a user discharges drinking water from the cold water tank 50, supposing that this is low-temperature drinking water, the user could get burned because the drinking water actually discharged is high-temperature drinking water used to sterilize the cold water tank 50.

An object of the present invention is to provide a water dispenser which is hygienic, and which allows use of low-temperature drinking water even during sterilization operation.

### Means for Achieving the Object

The inventor of the present invention discovered that if the portion of the cold water tank above the baffle plate is separated from the remaining portion of the cold water tank as a separate buffer tank, it is possible to stably keep the drinking water in the cold water tank at low temperature, thus preventing proliferation of germs in the cold water tank. The inventor further discovered that if the buffer tank is sterilized using high-temperature drinking water in the hot water tank such that the high-temperature drinking water does not flow through the cold water tank, a user can use low-temperature drinking water even during sterilization operation. Thus, with this arrangement, the above-described object is achieved.

Based on this discovery, the inventor of the present application provides the below-described water dispenser:

A water dispenser comprising a cold water tank capable of storing low-temperature drinking water to be discharged to outside, a replaceable raw water container filled with drinking water to be supplied into the cold water tank, a raw water pumping pipe through which the raw water container communicates with the cold water tank, a pump provided at an intermediate portion of the raw water pumping pipe, a hot water tank capable of storing high-temperature drinking water to be discharged to outside, a heater capable of heating drinking water in the hot water tank, a buffer tank disposed above the hot water tank and capable of storing drinking water which is used to push high-temperature drinking water in the hot water tank to outside when discharging the high-temperature drinking water to outside, a hot water tank supply pipe through which the buffer tank communicates with the hot water tank, a first three-way valve provided at a portion of the raw water pumping pipe between the pump and the cold water tank, a second three-way valve provided at a portion of the raw water pumping pipe between the pump and the raw water container, a buffer tank supply pipe through which the first three-way valve communicates with the buffer tank, and a circulation pipe through which the second three-way valve communicates with the hot water tank,

wherein the first three-way valve is configured to be switchable between a cold water-side connecting position in which the first three-way valve allows communication between the pump and the cold water tank, while blocking communication between the pump and the buffer tank, and a buffer-side connecting position in which the first three-way valve blocks communication between the pump and the cold water tank, while allowing communication between the pump and the buffer tank, and

wherein the second three-way valve is configured to be switchable between a raw water-side connecting position in which the second three-way valve allows communication between the pump and the raw water container, while blocking communication between the pump and the hot water tank, and a circulation-side connecting position in which the second three-way valve blocks communication between the pump and the raw water container, while allowing communication between the pump and the hot water tank.

With this arrangement, when discharging high-temperature drinking water in the hot water tank, the drinking water in the buffer tank, which is separate from the cold water tank, serves to push drinking water in the hot water tank to outside. Since the first three-way valve blocks communication between the buffer tank and the cold water tank, high-temperature drinking water in the hot water tank, which communicates with the buffer tank, will never flow into the low-temperature drinking water in the cold water tank. In other words, drinking water used to push drinking water in the hot water tank to outside is isolated from the low-temperature drinking water in the cold water tank. This makes it possible to keep the drinking water in the cold water tank stably at low temperature, and thus prevent proliferation of germs in the cold water tank. By driving the pump with the first three-way valve in the buffer-side connecting position and the second three-way valve in the circulation-side connecting position, high-temperature drinking water in the hot water tank can be fed into the raw water pumping pipe and the buffer tank, to sterilize the raw water pumping pipe and the buffer tank. Since the high-temperature drinking water in the hot water tank does not flow through the cold water tank at this time, a user can use low-temperature drinking water in the cold water tank even during the sterilization operation.

The water dispenser may further comprise a control device for controlling the first three-way valve, the second three-way valve, the pump and the heater.

The control device may be configured, during a normal operation mode, to perform a water level control in which when a water level in the cold water tank falls below a predetermined lower limit, the control device drives the pump with the first three-way valve in the cold water-side connecting position and the second three-way valve in the raw water-side connecting position, and when the water level in the buffer tank falls below a predetermined lower limit, the control device drives the pump with the first three-way valve in the buffer-side connecting position and the second three-way valve in the raw water-side connecting position, and to perform a heater control in which when the temperature in the hot water tank falls below a predetermined lower limit, the control device turns on the heater, thereby increasing the temperature in the hot water tank, and

the control device may be further configured, during a sterilization operation mode, to stop the water level control and to perform, simultaneously with the heater control, a water circulation control in which the control device drives the pump with the first three-way valve in the buffer-side connecting position and the second three-way valve in the circulation-side connecting position.

In this arrangement, during the sterilization operation, drinking water is circulated through the raw water pumping pipe and the buffer tank, and the temperature of the drinking water being circulated is raised. It is thus possible to reliably and positively sterilize the raw water pumping pipe and the buffer tank with high-temperature drinking water. Since the water level control is stopped during the sterilization operation, even when a user discharges low-temperature drinking water in the cold water tank to outside during the sterilization operation, and as a result, the water level in the cold water tank decreases, high-temperature drinking water being circulated through the raw water piping pipe will never be fed into the cold water tank. This makes it possible to keep the drinking water in the cold water tank at low temperature.

Preferably, the control device is configured, during the water circulation control, to deactivate the pump until the temperature in the hot water tank increases to a predetermined high temperature by the heater control, after every time the pump has been continuously driven for a predetermined period of time.

That is, the pump could be continuously driven (i.e. without stopping) from the beginning to the end of the sterilization operation. However, in this arrangement, since the pump is kept continuously driven even while the temperature of the circulating drinking water has not yet reached the sterilization temperature, the total number of revolutions of the pump per sterilization operation tends to be large, which could make it necessary to increase the interval between sterilization operations (to e.g. one week) in order not to shorten the life of the pump. Therefore, as described above, the control device is preferably configured, during the water circulation control, to deactivate the pump until the temperature in the hot water tank increases to a predetermined high temperature by the heater control, after every time the pump has been continuously driven for a predetermined period of time. With this arrangement, since the temperature of the drinking water in the hot water tank is raised with the pump deactivated, and the pump is driven only after the water temperature has risen to a predetermined high temperature, it is possible to reduce the total number of revolutions of the pump necessary to increase the temperature of the circulating drinking water to the sterilizing temperature, and thus to reduce the total number of revolutions of the pump per sterilization operation. This in turn makes it possible to shorten the intervals between sterilization operations (to e.g. about one day) without shortening the life of the pump.

Preferably, the control device is configured to drive the pump such that the revolving speed of the pump when the pump is driven during the sterilization operation mode is lower than the revolving speed at which the pump is driven during the normal operation mode. With this arrangement, it is possible to reduce the driving noise of the pump during the sterilization operation, thus ensuring quiet sterilization operation, which is supposed to be carried out at midnight.

In one arrangement, the circulation pipe has on the side of the hot water tank an end portion connected to a top surface of the hot water tank, and

the control device is configured, when supplying water into the hot water tank while the hot water tank is empty, to perform a raw water pump-up step in which the control device drives the pump with the first three-way valve in the buffer-side connecting position and the second three-way valve in the raw water-side connecting position, while keeping the heater off, and to perform, alternating with the raw water pump-up step, a non-heating circulation step in which the control device drives the pump with the first three-way valve in the buffer-side connecting position and the second three-way valve in the circulation-side connecting position, while keeping the heater off.

With this arrangement, when supplying water into the hot water tank while the hot water tank is empty (such as when supplying drinking water into a brand-new water dispenser, or when re-supplying drinking water into an existing water dispenser after draining drinking water for maintenance), water can be reliably supplied into the hot water tank, which prevents the hot water tank from being heated by the heater with no or insufficient water in the hot water tank.

In particular, when supplying water into the hot water tank while the hot water tank is empty, it is necessary to discharge the same amount of air as the amount of drinking water introduced into the hot water tank, out of the hot water tank. If air is not discharged smoothly, it is impossible to introduce drinking water into the hot water tank. That is, even though water can be supplied into the buffer tank, water in the buffer tank cannot be smoothly moved into the hot water tank if air cannot be discharged smoothly. If, as a result, the heater is turned on while the water level in the hot water tank has not sufficiently risen, the hot water tank will be heated by the heater with little water in the hot water tank. Once this happens, even after the hot water tank has been filled with drinking water, drinking water may smell and/or taste bad.

Therefore, as described above, the control device is preferably configured, when supplying water into the hot water tank while the hot water tank is empty, to perform a raw water pump-up step in which the control device drives the pump with the first three-way valve in the buffer-side connecting position and the second three-way valve in the raw water-side connecting position, while keeping the heater off, and to perform, alternating with the raw water pump-up step, a non-heating circulation step in which the control device drives the pump with the first three-way valve in the buffer-side connecting position and the second three-way valve in the circulation-side connecting position, while keeping the heater off. With this arrangement, during the raw water pump-up step, drinking water in the raw water container is fed through the raw water pumping pipe, the first three-way valve and then the buffer tank supply pipe, and introduced into the buffer tank, so that the water level in the buffer tank rises. During the non-heating circulation step, air collected in the top portion of the hot water tank is discharged through the circulation pipe, which allows the same amount of drinking water as the discharged air to be moved into the hot water tank. Thus, since the raw water pump-up step, in which drinking water is pumped up into the buffer tank, is carried out alternating with the non-heating circulation step, in which drinking water in the buffer tank is moved into the hot water tank, water can be reliably supplied into the hot water tank.

The control device may be configured to turn on the heater if the control device determines that the water level in the buffer tank immediately after the non-heating circulation step is equal to or higher than a predetermined threshold value. With this arrangement, it is possible to automatically turn on the heater as soon as it becomes apparent that enough water is in the hot water tank.

Preferably, the water dispenser further comprises a hot water discharge pipe through which high-temperature drinking water in the hot water tank can be discharged to outside, and which includes an end portion on the side of the hot water tank, the end portion of the hot water discharge pipe having an opening spaced downwardly from the top surface of the hot water tank, wherein the end portion of the circulation pipe on the side of the hot water tank has an opening located at a higher level than the opening of the end portion of the hot water discharge pipe on the side of the hot water tank.

This arrangement prevents high-temperature air from blowing out from the hot water discharge pipe when a user discharges high-temperature drinking water in the hot water tank.

In particular, when the drinking water in the hot water tank is heated by the heater, air dissolved in the drinking water could separate therefrom and stay in the hot water tank as the temperature of the drinking water rises. Such air could blow out of the hot water discharge pipe when discharging drinking water in the hot water tank. Therefore, as described above, the end portion of the hot water discharge pipe on the side of the hot water tank preferably has an opening spaced downward from the top surface of the hot water tank, and the end portion of the circulation pipe on the side of the hot water tank preferably has an opening located at a higher level than the opening of the end portion of the hot water discharge pipe on the side of the hot water tank. With this arrangement, since the end portion of the hot water discharge pipe on the side of the hot water tank has an opening spaced downwardly from the top surface of the hot water tank, air collected along the top surface of the hot water tank is less likely to be introduced into the hot water discharge pipe. Also, air collected along the top surface of the hot water tank is discharged from the hot water tank through the circulation pipe during the sterilization operation. This prevents high-temperature air from being blown out of the hot water discharge pipe when a user discharges high-temperature drinking water in the hot water tank.

### Advantages of the Invention

In the water dispenser according to the present invention, drinking water used to push drinking water in the hot water tank to outside is isolated from the low-temperature drinking water in the cold water tank. This makes it possible to keep the drinking water in the cold water tank stably at low temperature, and to prevent proliferation of germs. By driving the pump with the first three-way valve in the buffer-side connecting position, and the second three-way valve in the circulation-side connecting position, high-temperature drinking water in the hot water tank is fed into the raw water pumping pipe and the buffer tank, so that it is possible to sterilize the raw water pumping pipe and the buffer tank. Thus, the water dispenser according to the present invention is highly hygienic because proliferation of germs in the cold water tank is prevented by keeping the drinking water in the cold water tank at low temperature, and the raw water pumping pipe and the buffer tank, which are brought into contact with relatively high temperature drinking water which has been pumped out of the raw water container, are sterilized by high-temperature drinking water. When sterilizing the raw water pumping pipe and the buffer tank using high-temperature drinking water in the hot water tank, the high-temperature drinking water does not flow through the cold water tank, so that a user can use low-temperature drinking water in the cold water tank during the sterilization operation.

### BRIEF DESCRIPTION OF THE DRAWINGS

FIG. 1 is a sectional view of a water dispenser embodying the present invention, during a normal operation mode.

FIG. 2 is a sectional view of the water dispenser, during a sterilization operation mode.

FIG. 3 is a sectional view of the water dispenser while the water dispenser is brand new (and its cold water tank, hot water tank and buffer tank are all empty).

FIG. 4 is a sectional view of the water dispenser showing the state in which, in the state of FIG. 3, water is supplied into the cold water tank from a raw water container set on the water dispenser.

FIG. 5 is a sectional view of the water dispenser while raw water is being pumped up.

FIG. 6 is a sectional view of the water dispenser while the control device is performing a non-heating circulation step after a raw water pump-up step.

FIG. 7 is a sectional view of the water dispenser while low-temperature drinking water is being discharged from the cold water tank shown in FIG. 1.

FIG. 8 is a sectional view of the water dispenser while high-temperature drinking water is being discharged from the hot water tank shown in FIG. 1.

FIG. 9 is a sectional view of and around a container holder shown in FIG. 1 when the container holder has been pulled out of a housing.

FIG. 10(a) is an enlarged sectional view of and around a guide plate shown in FIG. 7; and FIG. 10(b) is a sectional view taken along line B-B of FIG. 10(a).

FIG. 11 is an enlarged sectional view of the hot water tank, showing how air dissolved in drinking water in the hot water tank is separated from the drinking water in the form of air bubbles and collects in the upper portion of the hot water tank, when the drinking water in the hot water tank is heated by a heater shown in FIG. 1.

FIG. 12 is a block diagram of the control device of the water dispenser of FIG. 1.

FIG. 13 is a flow chart showing a water level control performed by the control device shown in FIG. 12.

FIG. 14 is a flow chart showing heater control of the hot water tank performed by the control device shown in FIG. 12.

FIG. 15 is a flow chart of a water circulation control performed by the control device shown in FIG. 12.

FIG. 16 is a flow chart showing a control performed by the control device shown in FIG. 12 when supplying water into the hot water tank while the hot water tank is empty.

FIG. 17 is a sectional view of a water dispenser as a reference example which was manufactured in-house by the inventor of the present application for in-house evaluation.

### BEST MODE FOR EMBODYING THE INVENTION

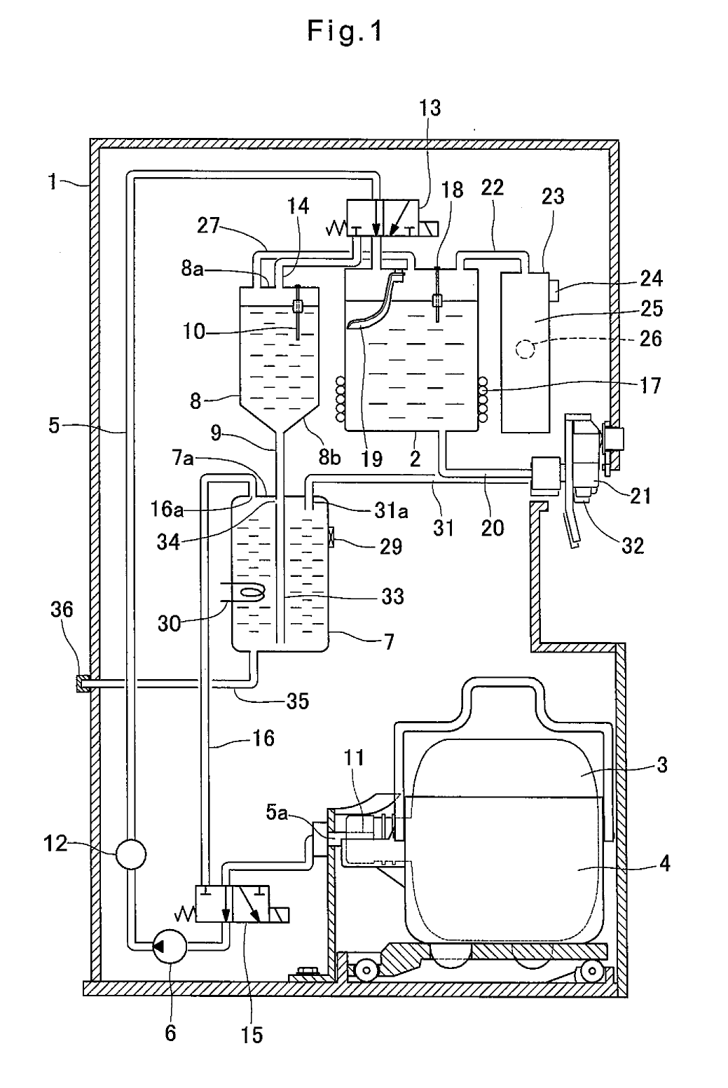

FIG. 1 shows a water dispenser embodying the present invention. This water dispenser includes a housing 1, a cold water tank 2 in which is stored low-temperature drinking water to be discharged to the outside of the housing 1, a replaceable raw water container 3 filled with drinking water to be supplied to the cold water tank 2, and a container holder 4 supporting the raw water container 3. The raw water container 3 communicates with the cold water tank 2 through a raw water pumping pipe 5 provided with a pump 6 at its intermediate portion. The water dispenser further includes a hot water tank 7 in which is stored high-temperature drinking water to be discharged to the outside of the housing 1, and a buffer tank 8 provided over the hot water tank 7 and communicating with the hot water tank 7 through a hot water tank supply pipe 9.

The raw water pumping pipe 5 has at its upstream end a joint portion 5a configured to be detachably connected to a water outlet 11 of the raw water container 3. The raw water pumping pipe 5 is connected at its downstream end to the cold water tank 2. The raw water pumping pipe 5 extends downwardly from the joint portion 5a and is then bent to extend upwardly, so that the raw water pumping pipe 5 includes a portion located lower than the joint portion 5a. The pump 6 is provided at this portion of the raw water pumping pipe 5, namely, its portion located lower than the joint portion 5a.

The pump 6 is configured to transfer drinking water in the raw water pumping pipe 5 from the side of the raw water container 3 toward the cold water tank 2, thereby drawing drinking water in the raw water container 3 through the raw water pumping pipe 5. The pump 6 may be a diaphragm pump. While not shown, such a diaphragm pump includes a reciprocating diaphragm, a pump chamber configured such that its volume changes as the diaphragm reciprocates and having a suction port and a discharge port, a suction port side check valve provided at the suction port so as to allow only the flow of water into the pump chamber, and a discharge port side check valve provided at the discharge port so as to allow only the flow of water out of the pump chamber, and is arranged such that when the volume of the pump chamber increases due to reciprocating motion of the diaphragm, drinking water is sucked into the pump chamber through the suction port, and when the volume of the pump chamber decreases, drinking water is discharged from the pump chamber through the discharge port.

Alternatively, the pump 6 may be a gear pump. While not shown, such a gear pump includes a casing, a pair of gears mounted in the casing so as to mesh with each other, and a suction chamber and a discharge chamber that are defined in the casing through the meshing portions of the gears, and are configured such that drinking water trapped between the tooth grooves of the respective gears and the inner surface of the casing is transferred from the suction chamber to the discharge chamber when the gears are rotated.

A flow rate sensor 12 is provided in the portion of the raw water pumping pipe 5 on the discharge port side of the pump 6. The flow rate sensor 12 is capable of detecting the fact that there is no drinking water flowing in the raw water pumping pipe 5 while the pump 6 is being driven. When the sensor 12 detects this fact, a container replacement lamp, not shown, but mounted on the front side of the housing 1, is turned on to notify a user of the necessity to replace the raw water container 3.

A first three-way valve 13 is provided in the portion of the raw water pumping pipe 5 between the pump 6 and the cold water tank 2 (preferably at the end portion of the pipe 5 on the side of the cold water tank 2). While in the figures, the first three-way valve 13 is spaced from the cold water tank 2, the first three-way valve 13 may be directly connected to the cold water tank 2. A buffer tank supply pipe 14 is connected to the first three-way valve 13 such that the first three-way valve 13 communicates with the buffer tank 8 through the buffer tank supply pipe 14. The buffer tank supply pipe 14 is connected at its end on the side of the buffer tank 8 to the top surface 8a of the buffer tank 8.

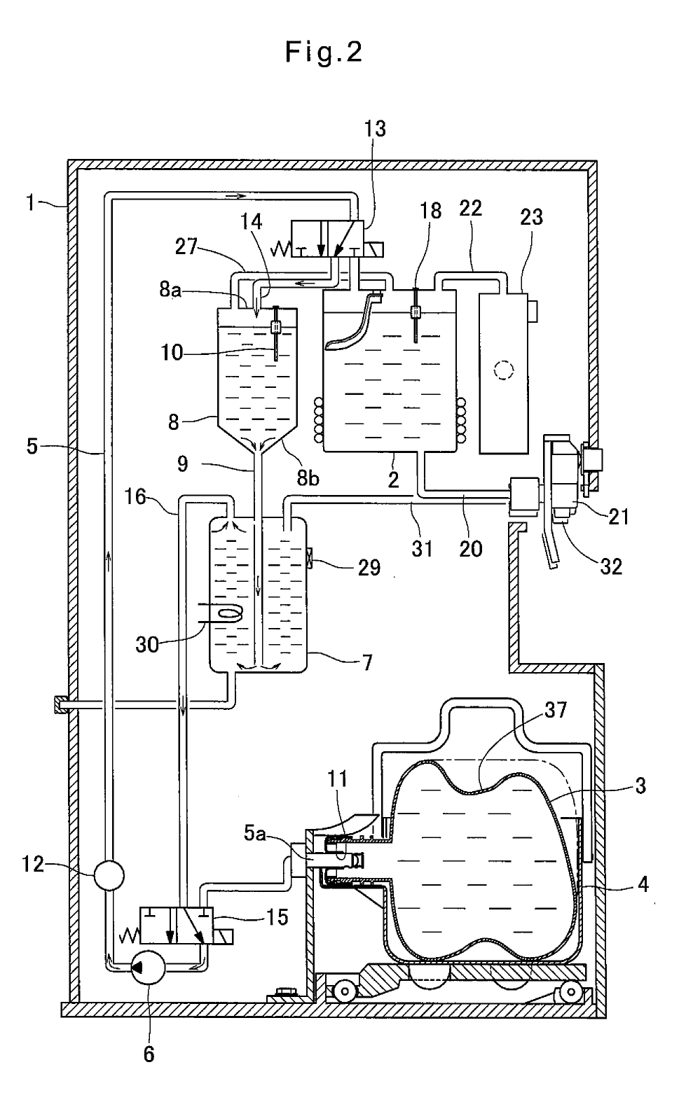

The first three-way valve 13 is switchable between a cold water-side connecting position where the first three-way valve 13 allows communication between the pump 6 and the cold water tank 2, while blocking communication between the pump 6 and the buffer tank 8 (see FIG. 1), and a buffer-side connecting position where the first three-way valve 13 blocks communication between the pump 6 and the cold water tank 2, while allowing communication between the pump 6 and the buffer tank 8 (see FIG. 2). The first three-way valve 13 is an electromagnetic valve configured to be switched from the cold water-side connecting position to the buffer-side connecting position when energized, and switched from the buffer-side connecting position to the cold water-side connecting position when de-energized.

A second three-way valve 15 is provided in the portion of the raw water pumping pipe 5 between the pump 6 and the raw water container 3 (preferably at the end portion of the pipe 5 on the side of the raw water container 3). While in the figures, the second three-way valve 15 is spaced from the joint portion 5a, the second three-way valve 15 may be directly connected to the joint portion 5a. A circulation pipe 16 is connected to the second three-way valve 15 such that the second three-way valve 15 communicates with the hot water tank 7 through the circulation pipe 16. The circulation pipe 16 is connected at its end on the side of the hot water tank 7 to the top surface 7a of the hot water tank 7.

The second three-way valve 15 is switchable between a raw water-side connecting position where the second three-way valve 15 allows communication between the pump 6 and the raw water container 3, while blocking communication between the pump 6 and the hot water tank 7 (see FIG. 1), and a hot water-side connecting position (which is also hereinafter sometimes referred to as “circulation-side connecting position”) where the second three-way valve 13 blocks communication between the pump 6 and the raw water container 3, while allowing communication between the pump 6 and the hot water tank 7 (see FIG. 2). The second three-way valve 15 is an electromagnetic valve configured to be switched from the raw water-side connecting position to the hot water-side connecting position when energized, and switched from the hot water-side connecting position to the raw water-side connecting position when de-energized.

Each of the first three-way valve 13 and second three-way valve 15 may be replaced by a three-way valve assembly comprising a plurality of two-way valves and equivalent in function to each of the valves 13 and 15.

Air and drinking water are stored in the cold water tank 2 in upper and lower layers. A cooling device 17 is mounted to the cold water tank 2 to cool the drinking water stored in the cold water tank 2. The cooling device 17 is provided on the outer periphery of the cold water tank 2 at its lower portion, and functions to keep the drinking water in the cold water tank 2 at a low temperature (about 5 degrees Celsius).

A water level sensor 18 is mounted in the cold water tank 2 and configured to detect the level of the drinking water stored in the cold water tank 2. When the water level detected by the water level sensor 18 falls to a predetermined level, the pump 6 is activated with the first three-way valve 13 switched to the cold water-side connecting position, and as a result, drinking water in the raw water container 3 is drawn up toward the cold water tank 2.

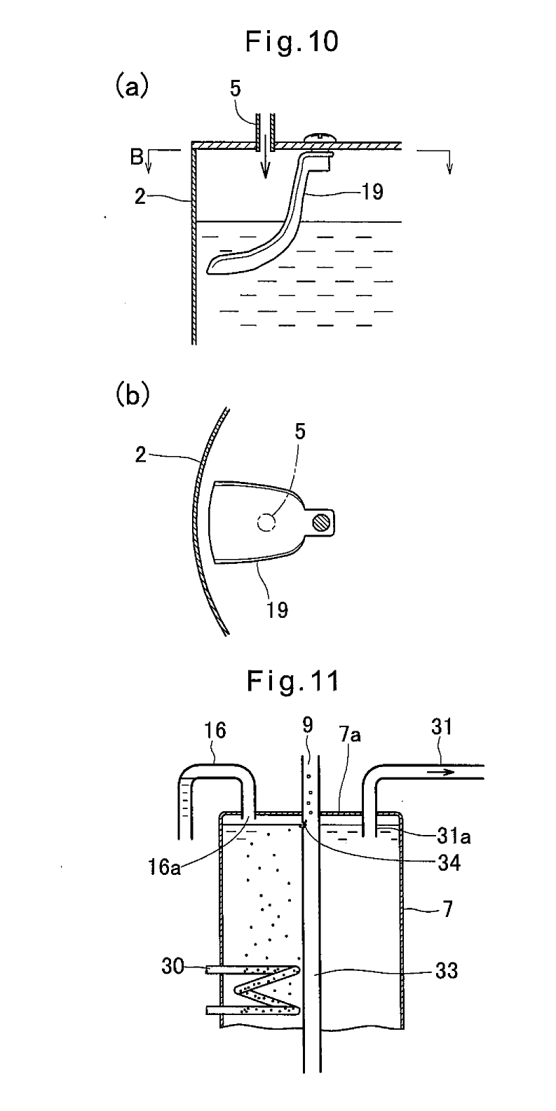

As shown in FIGS. 10(a) and 10(b), a guide plate 19 is provided in the cold water tank 2. The guide plate 19 is configured to change the vertical flow of drinking water flowing into the cold water tank 2 from the raw water pumping pipe 5 when drinking water is drawn up toward the cold water tank 2 from the raw water container 3, to a horizontal flow. The guide plate 19 thereby prevents the low-temperature drinking water collected in the lower portion of the cold water tank 2 from being stirred by normal-temperature drinking water flowing into the cold water tank 2 from the raw water pumping pipe 5.

As shown in FIG. 1, a cold water discharge pipe 20 is connected to the bottom of the cold water tank 2 such that low-temperature drinking water in the cold water tank 2 can be discharged to the outside through the cold water discharge pipe 20. The cold water discharge pipe 20 is provided with a cold water cock 21 operable from outside the housing 1 and configured such that by opening the cold water cock 21, low-temperature drinking water can be discharged into e.g. a cup. The capacity of the cold water tank 2 is smaller than that of the raw water container 3, and is about 2 to 4 liters.

An air sterilizing chamber 23 is connected to the cold water tank 2 through an air introducing line 22. The air sterilizing chamber 23 includes a hollow case 25 formed with an air intake port 24, and an ozone generator 26 mounted in the case 25. The ozone generator 26 may be a low-pressure mercury lamp, which emits ultraviolet rays to change oxygen in the air to ozone, or a silent discharge device, which includes an opposed pair of electrodes covered by insulating material and is configured to change oxygen between the electrodes by applying an alternating voltage to the electrodes. The ozone generator 26 of the air sterilizing chamber 23 is configured to be energized at regular intervals to generate ozone, thereby filling the case 25 with ozone.

As the water level in the cold water tank 2 decreases, air is introduced into the cold water tank 2 through the air introduction line 22, so that the interior of the cold water tank 2 is kept at atmospheric pressure. Since air to be introduced into the cold water tank 2 passes through the air sterilizing chamber 23 and is sterilized by ozone therein, air in the cold water tank 2 is kept clean.

In the buffer tank 8, air and drinking water are stored in upper and lower layers. An air vent pipe 27 is connected to the top surface 8a of the buffer tank 8 such that the air layer in the buffer tank 8 communicates with the air layer in the cold water tank 2 through the air vent pipe 27, thereby keeping the interior of the buffer tank 8 at atmospheric pressure.

A water level sensor 10 is mounted in the buffer tank 8 to detect the level of drinking water stored in the buffer tank 8. When the water level detected by the water level sensor 10 falls to a predetermined level, the pump 6 is activated with the first three-way valve 13 switched to the buffer-side connecting position, so that drinking water is drawn up into the buffer tank 8 from the raw water container 3.

The capacity of the buffer tank 8 to hold water is smaller than the capacity of the hot water tank 7, and is about 0.2 to 0.5 liters. The drinking water in the buffer tank 8 serves to push high-temperature drinking water in the hot water tank 7 out of the tank 7 when discharging it. For this reason, the buffer tank 8 is preferably vertically elongated (for example, the buffer tank 8 may be a cylindrical member having a height larger than its diameter). With this arrangement, even if the capacity of the buffer tank 8 to hold water is small, a relatively high water pressure is generated at the bottom portion of the buffer tank 8, so that drinking water in the hot water tank 7 can be pushed out of the tank 7 under the sufficiently large water pressure. In the figures, the buffer tank 8 is arranged such that the water level in the buffer tank 8 is at the same height as or lower than the water level in the cold water tank 2, but may instead be arranged such that the water level in the buffer tank 8 is higher than the water level in the cold water tank 2. With the latter arrangement, since the height difference between the buffer tank 8 and the hot water tank 7 is larger than with the former arrangement, the force with which drinking water in the hot water tank 7 is pushed out increases.

The bottom surface 8b of the buffer tank 8 has the shape of a cone, namely, its height gradually decreases toward its center. The hot water tank supply pipe 9 is connected to the center of the bottom surface 8b, and is also connected to the hot water tank 7, which is disposed under the buffer tank 8. By making the bottom surface 8b of the buffer tank 8 conical in shape, during the below-described sterilization mode, high-temperature drinking water can be supplied even to the outer peripheral corner of the bottom surface 8b of the buffer tank 8, thereby leaving no portion unsterilized.

The hot water tank 7 is completely filled with drinking water. In the hot water tank 7, there are mounted a temperature sensor 29 for detecting the temperature of the drinking water in the hot water tank 7, and a heater 30 for heating the drinking water in the hot water tank 7. The heater 30 is configured to be selectively turned on and off according to the temperature detected by the temperature sensor 29 so that the drinking water in the hot water tank 7 is kept at a high temperature (about 90 degrees Celsius). A sheath heater is used as the heater 30 in the figures, but a band heater may be used instead. The sheath heater includes a metal pipe and a heat-generating wire received in the pipe and configured to generate heat when energized, and is mounted in position so as to extend through the wall of the hot water tank 7 and in the hot water tank 7. A band heater is a cylindrical heat-generating member in which is embedded a heat-generating wire configured to generate heat when energized, and is mounted to the hot water tank 7 so as to be kept in close contact with the outer periphery of the hot water tank 7.

A hot water discharge pipe 31 is connected to the top surface 7a of the hot water tank 7 such that high-temperature drinking water accumulated in the upper portion of the hot water tank 7 can be discharged to the outside through the hot water discharge pipe 31. The hot water discharge pipe 31 is provided with a hot water cock 32 operable from outside the housing 1 and configured such that by opening the hot water cock 32, high-temperature drinking water can be discharged into e.g. a cup from the hot water tank 7. When drinking water is discharged from the hot water tank 7, drinking water in the buffer tank 8 flows through the hot water tank supply pipe 9 and is introduced by gravity into the hot water tank 7, so that the hot water tank 7 is always filled up with water. The capacity of the hot water tank 7 to hold water is about 1 to 2 liters.

The hot water tank supply pipe 9 includes an in-tank pipe portion 33 extending downward in the hot water tank 7 from the top surface 7a of the hot water tank 7. The in-tank pipe portion 33 has an open bottom end located in the vicinity of the bottom surface of the hot water tank 7. The in-tank pipe portion 33 has, at its portion in the vicinity of the top surface 7a of the hot water tank 7, a small hole 34 through which the interior of the in-tank pipe portion 33 communicates with the exterior.

The end portion 31a of the hot water discharge pipe 31 on the side of the hot water tank 7 extends through the top surface 7a of the hot water tank 7 and further extends in the hot water tank 7 downward so as to open at a position spaced downward (e.g. by about 5 to 15 mm) from the top surface 7a of the hot water tank 7. The small hole 34 of the in-tank pipe portion 33 of the hot water tank supply pipe 9 is located higher than the opening of the end portion 31a of the hot water discharge pipe 31. The end portion 16a of the circulation pipe 16 is open at a position higher than the small hole 34 of the in-tank pipe portion 33 of the hot water tank supply pipe 9.

A drain pipe 35 is connected to the bottom surface of the hot water tank 7 and extends to the outside of the housing 1. The outlet of the drain pipe 35 is closed by a plug 36, but may be provided with an on-off valve instead of the plug 36.

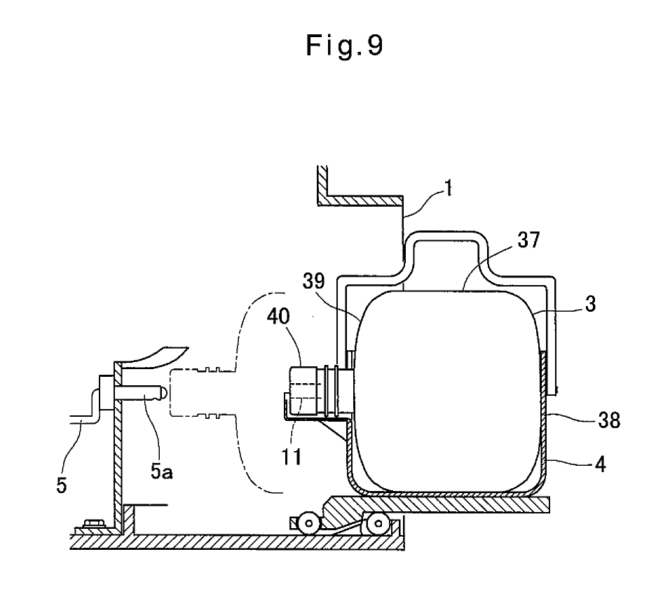

As shown in FIG. 9, the raw water container 3 includes a hollow, tubular trunk portion 37, a bottom portion 38 provided at one end of the trunk portion 37, and a neck portion 40 connected to the other end of the trunk portion 37 through a shoulder portion 39. The neck portion 40 is provided with the water outlet 11. The trunk portion 37 of the raw water container 3 is flexible so as to be collapsible as the water remaining in the raw water container 3 decreases. The raw water container 3 is formed by blow-molding of polyethylene terephthalate (PET) resin. The raw water container 3 can hold up to about 10 to 20 liters of water.

Alternatively, the raw water container 3 may be a box (such as a corrugated cardboard box) in which is received a resin film bag to which is bonded a connecting fixture having the water outlet 11. by e.g. heat welding (such a container is known as a “bag-in box”).

The container holder 4 is supported so as to be horizontally movable between a storage position (shown in FIG. 1) in which the raw water container 3 is stored in the housing 1 and a pulled-out position (shown in FIG. 9) in which the raw water container 3 has been moved out of the housing 1. The joint portion 5a is fixed in position in the housing 1 such that when the container holder 4 is in the pulled-out position, the joint portion 5a is disconnected from the water outlet 11 of the raw water container 3 as shown in FIG. 9, and when the container holder 4 is in the storage position, the joint portion 5a is connected to the water outlet 11 of the raw water container 3 as shown in FIG. 1.

The raw water pumping pipe 5 may comprise a silicone tube (except its joint portion 5a). However, since silicone is permeable to air, if a raw water pumping pipe 5 in the form of a silicone tube is used, oxygen in the air that permeates the pipe 5 tends to cause proliferation of germs in the pipe 5. Therefore, a metal pipe (such as a stainless steel pipe or a copper pipe) may be used as the raw water pumping pipe 5. By using such a pipe, since air cannot permeate the wall of the raw water pumping pipe 5, it is possible to effectively prevent proliferation of germs. Another advantage of such a metal pipe is that it is sufficiently resistant to heat generated during sterilization operation. If a polyethylene tube or a heat-resistant hard polyvinyl chloride pipe is used as the raw water pumping pipe 5 too, it is possible to prevent permeation of air through the wall of the raw water pumping pipe 5 and thus proliferation of germs in the raw water pumping pipe 5.

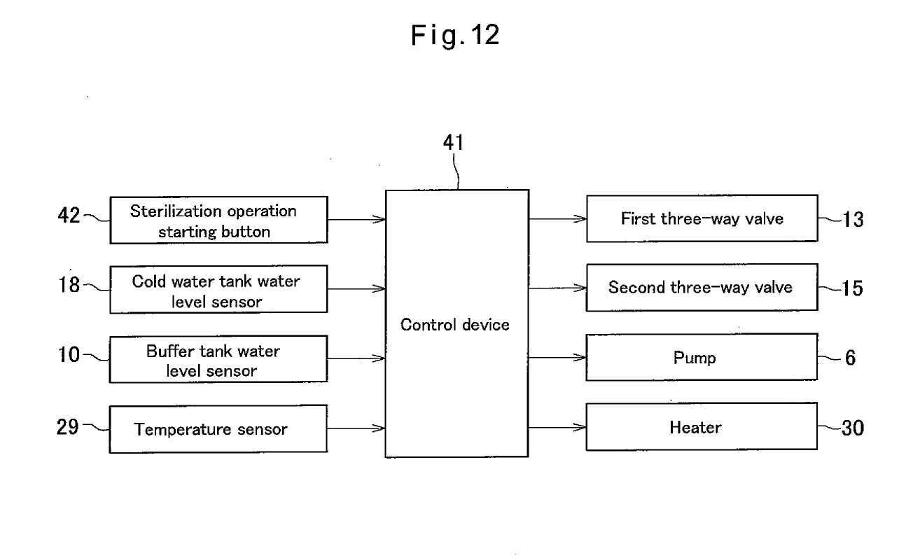

The first three-way valve 13, the second three-way valve 15, the pump 6 and the heater 30 are controlled by a control device 41 shown in FIG. 12. The control device 41 is configured to receive a signal from a sterilization operation starting button 42 indicating that the button 42 has been operated by a user, a signal from the water level sensor 18 indicative of the level of the drinking water stored in the cold water tank 2, a signal from the water level sensor 10 indicative of the level of the drinking water stored in the buffer tank 8, and a signal from the temperature sensor 29 indicative of the temperature of the drinking water in the hot water tank 7. Further, the control device 41 is configured to output a control signal for driving the pump 6, a control signal for selectively turning on and off the heater 30, a control signal for switching the position of the first three-way valve 13, and a control signal for switching the position of the second three-way valve 15.

The sterilization operation starting button 42 is used to start the sterilization operation. That is, when the sterilization operation starting button 42 is operated by a user, the initial sterilization operation starts. The second and later sterilization operations are automatically started at the intervals of one day (the time passed from the initial sterilization operation is counted by a timer built in the control device 41). The sterilization operation starting button 42 is provided at the front of the housing 1.

Now the control by the control device 41 is described.

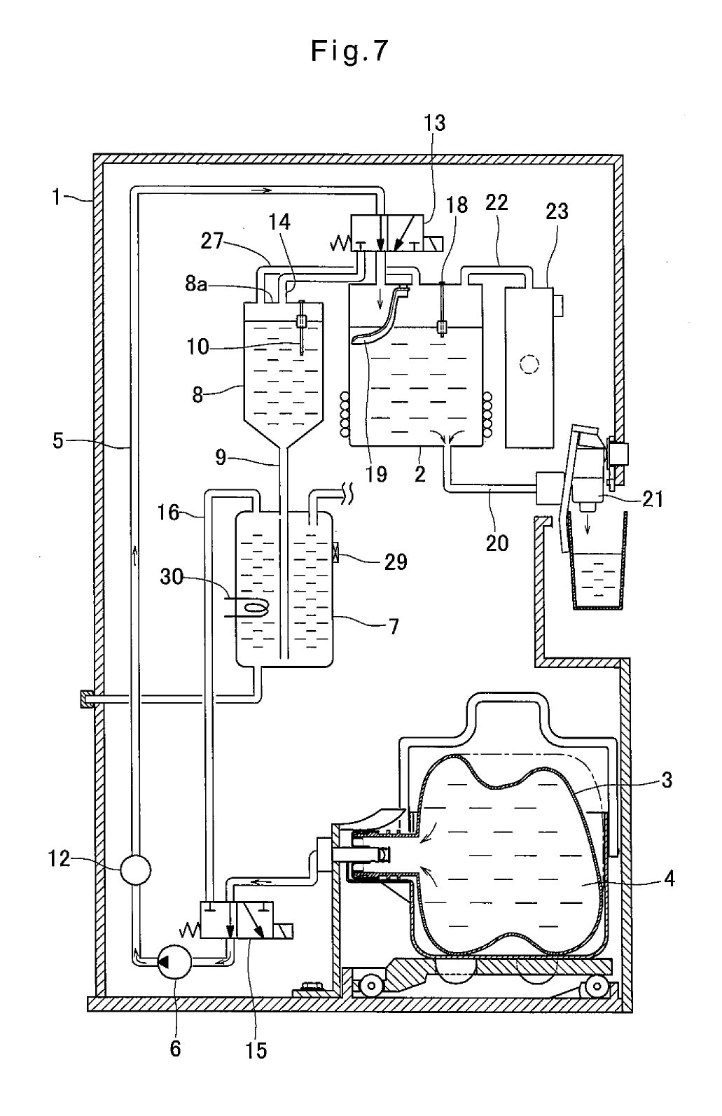

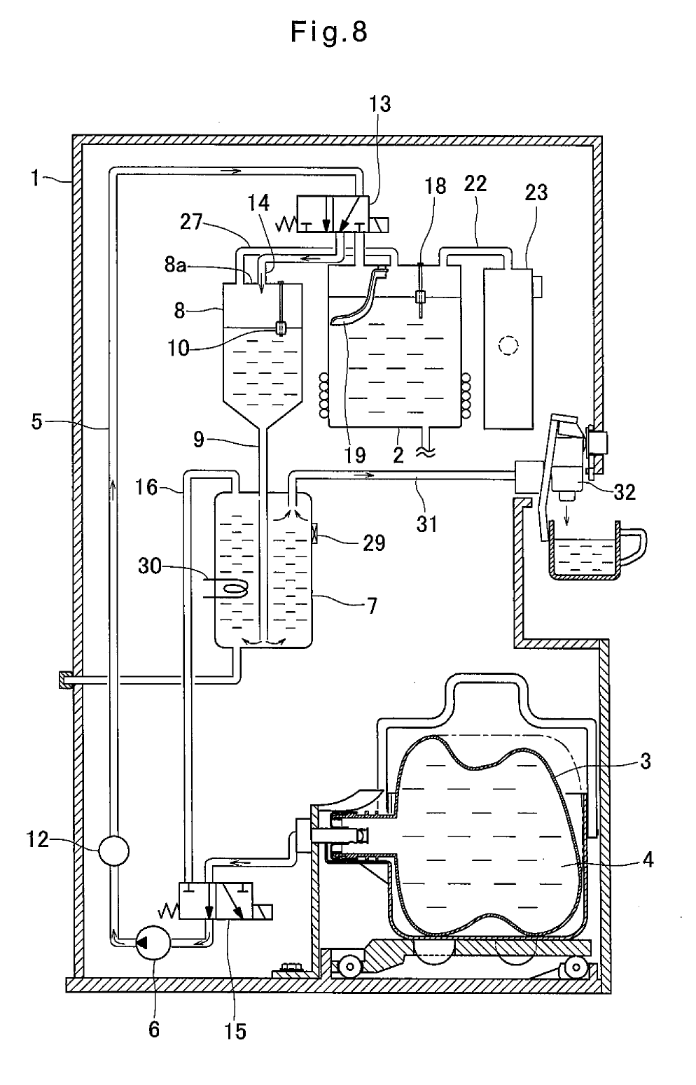

During the normal operation mode, as shown in FIGS. 7 and 8, the control device 41 controls the water level in the cold water tank 2 and the water level in the buffer tank 8 within predetermined ranges by moving the first three-way valve 13 between the cold water-side connecting position and the buffer-side connecting position, while activating the pump 6, with the second three-way valve 15 kept at the raw water-side connecting position. Simultaneously, the control device 41 performs heater control for keeping the drinking water in the hot water tank 7 at a high temperature.

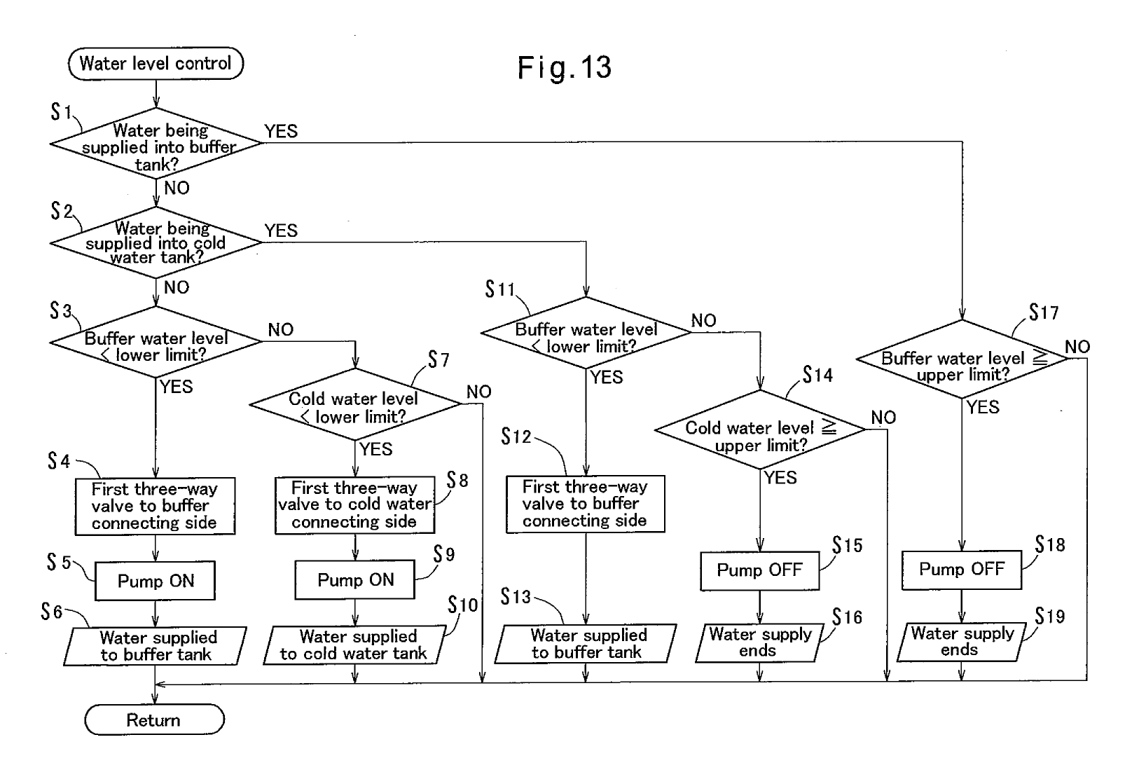

The water levels in the two tanks are controlled e.g. according the routine shown in FIG. 13. In particular, when the water level in the buffer tank 8 falls below a predetermined lower limit, the control device 41 moves the first three-way valve 13 to the buffer-side connecting position as shown in FIG. 8, and activates the pump 6 in this state (Steps S1 to S6). The second three-way valve 15 is held in the raw water-side connecting position all this while. As a result, drinking water drawn up from the raw water container 3 through the raw water pumping pipe 5 is supplied into the buffer tank 8. On the other hand, when the water level in the cold water tank 2 falls below a predetermined lower limit, the control device 41 moves the first three-way valve 13 to the cold water-side connecting position as shown in FIG. 7, and activates the pump 6 in this state (Steps S7 to S10). As a result, drinking water drawn up from the raw water container 3 through the raw water pumping pipe 5 is supplied into the cold water tank 2.

When the water level in the buffer tank 8 falls below the predetermined lower limit while water is being supplied into the cold water tank 2, the control device 42 moves the first three-way valve 13 from the cold water-side connecting position to the buffer-side connecting position (Step S11 to S13). As a result, the supply of water into the cold water tank 2 stops and the supply of water into the buffer tank 8 starts. That is, when it is necessary to supply water both into the buffer tank 8 and the cold water tank 2, water is supplied preferentially into the buffer tank 8. By preferentially supplying water into the buffer tank 8, it is possible to prevent the hot water tank 7 from being heated by the heater 30 with no water in the tank 7, even when a user simultaneously operates both the cold water cock 21 and the hot water cock 32, and as a result, the water levels in the cold water tank 2 and the buffer tank 8 simultaneously fall.

When, as a result of supplying water into the cold water tank 2, the water level in the cold water tank 2 reaches a predetermined upper limit, the control device 41 stops the pump 6, thereby terminating the supply of water into the cold water tank 2 (Steps S14 to S16). Similarly, when, as a result of supplying water into the buffer tank 8, the water level in the buffer tank 8 reaches a predetermined upper limit, the control device 41 stops the pump 6, thereby terminating the supply of water into the buffer tank 8 (Steps S17 to S19).

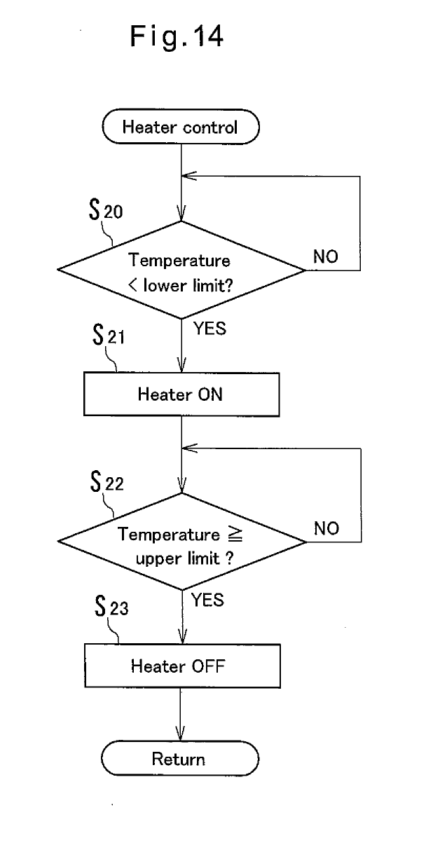

The control device 41 performs the heater control of the hot water tank 7 according to e.g. the routine shown in FIG. 14. In particular, when the temperature in the hot water tank 7 falls below a predetermined lower limit (e.g. 85 degrees Celsius), the control device 41 turns on the heater 30 to increase the temperature in the hot water tank 7 (Steps S20 and S21). When the temperature in the hot water tank 7 reaches a predetermined upper limit (e.g. 90 degrees Celsius) thereafter, the control device 41 turns off the heater 30 (Steps S22 and S23).

During the sterilization operation, the control device 41 stops the water level control. That is, even if the water level in the cold water tank 2 falls below the above-mentioned lower limit during the sterilization operation, drinking water is not drawn up into the cold water tank 2 from the raw water container 3. With the water level control deactivated, the control device 41 performs the water circulation control for circulating drinking water through the raw water pumping pipe 5 and the buffer tank 8, and simultaneously performs the heater control of the hot water tank 7, thereby increasing the temperature of the drinking water being circulated to a sterilizing temperature (e.g. 80 degrees Celsius). After the temperature of the drinking water being circulated reaches the sterilization temperature, the control device 41 continues the heater control and the water circulation control for a predetermined time period (e.g. 10 minutes), to sterilize the circulation path including the raw water pumping pipe 5 and the buffer tank 8 with high-temperature drinking water which has been heated to a temperature not lower than the sterilization temperature.

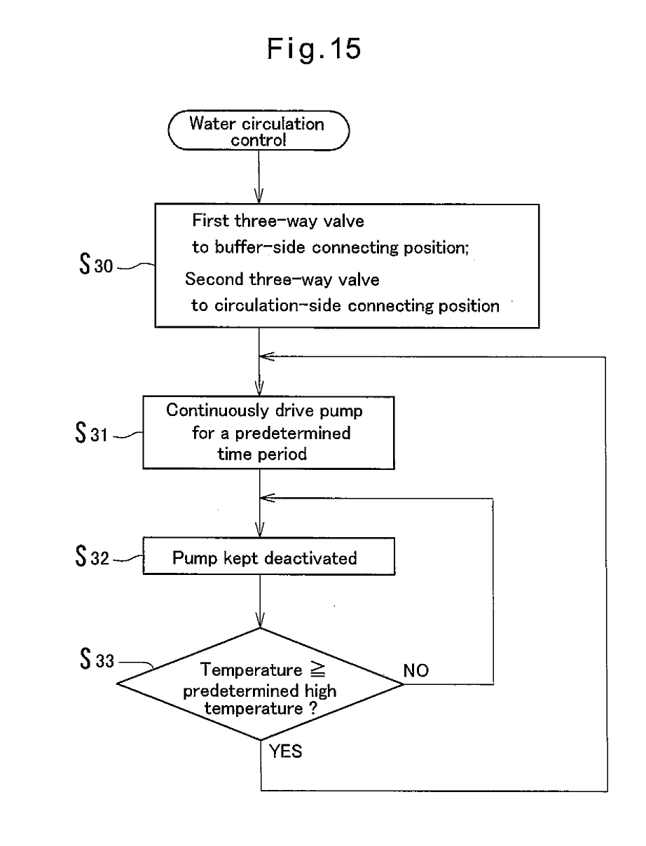

The control device 41 performs the water circulation control according to e.g. the routine shown in FIG. 15. In particular, the control device 41 first switches the first three-way valve 13 to the buffer-side connecting position, and switches the second three-way valve 15 to the circulation-side connecting position (Step S30), and then activates the pump 6 (Steps S31 to S33). As a result, as shown in FIG. 2, the high-temperature drinking water in the hot water tank 7 is circulated through the circulation pipe 16, second three-way valve 15, raw water pumping pipe 5, first three-way valve 13, buffer tank supply pipe 14, buffer tank 8 and hot water tank supply pipe 9 in this order. Thus, during the water circulation control, high-temperature drinking water does not flow through the cold water tank 2.

During the water circulation control, the pump 6 may be continuously driven from the start to the end of the sterilization operation. However, in this arrangement, since the pump 6 is kept continuously driven even while the temperature of the circulating drinking water has not yet reached the sterilization temperature, the total number of revolutions of the pump 6 per sterilization operation tends to be large, which could make it necessary to increase the interval between sterilization operations (to e.g. one week or longer) in order not to shorten the life of the pump 6.

Therefore, as shown in FIG. 15, the control device 41 is configured, during the sterilization operation, to intermittently drive the pump 6, namely, deactivate the pump 6 until the temperature in the hot water tank 7 increases to a predetermined high temperature by the heater control (Steps S32 and S32) after every time the pump 6 has been continuously driven for a predetermined period of time (Step S31). In this arrangement, since the drinking water in the hot water tank 7 is heated to the predetermined high temperature with the pump 6 deactivated, and the pump 6 is driven only after the drinking water in the hot tank 7 has been heated to or above the predetermined high temperature, the total number of revolutions of the pump 6 until the temperature of the circulating drinking water rises to the sterilizing temperature is small, and thus the total number of revolutions of the pump 6 per sterilization operation is also small. This makes it possible to shorten the interval between sterilization operations (to e.g. about one day) without shortening the life of the pump 6.

The predetermined high temperature in Step S33 is set to a temperature at least higher than the sterilizable temperature (65 degrees Celsius) (and not higher than the upper limit temperature of the heater control). Preferably, the predetermined high temperature is set to the lower limit temperature of the heater control (which is e.g. 85 degrees Celsius), because with this arrangement, if a thermostat is used as the temperature sensor 29 to perform the heater control, the pump 6 can be controlled in Steps S32 and S33 based on whether the thermostat is on or off. Instead, however, the predetermined high temperature may be equal to the upper limit temperature of the heater control (which is about 90 degrees Celsius).

The above-mentioned predetermined period of time during which the pump 6 is continuously driven (Step S31) before every time the pump 6 is deactivated may be equal to or longer than the period of time necessary for the pump 6 to feed drinking water by the amount corresponding to the capacity of the buffer tank 8. With this arrangement, every time the pump 6 is driven continuously, the drinking water in the buffer tank 8 can be completely replaced by high-temperature drinking water, so that the temperature of the drinking water in the circulation path can be efficiently raised to the sterilization temperature.

When driving the pump 6 during the sterilization operation (i.e. in Step S31), the control device 41 drives the pump 6 at a revolving speed lower than the revolving speed of the pump 6 when the pump 6 is driven during the normal operation mode 8 (i.e. in Steps S5 and S9). This reduces the driving noise of the pump 6 during the sterilization operation, i.e. ensures quiet sterilization operation, which is supposed to be carried out at midnight.

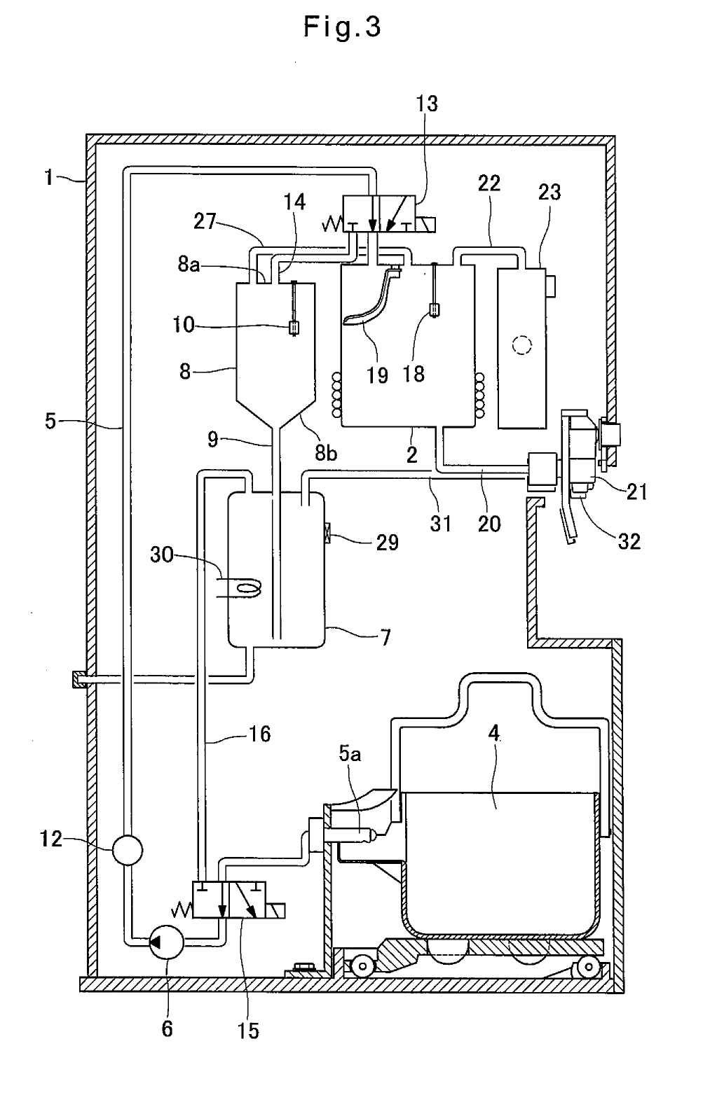

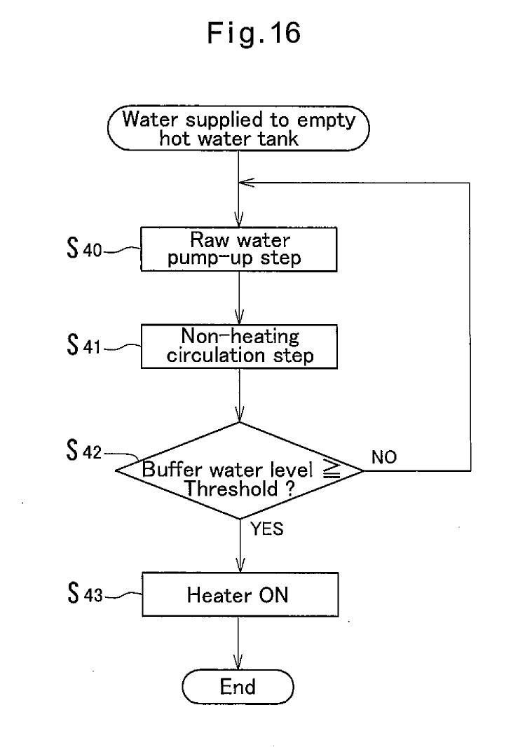

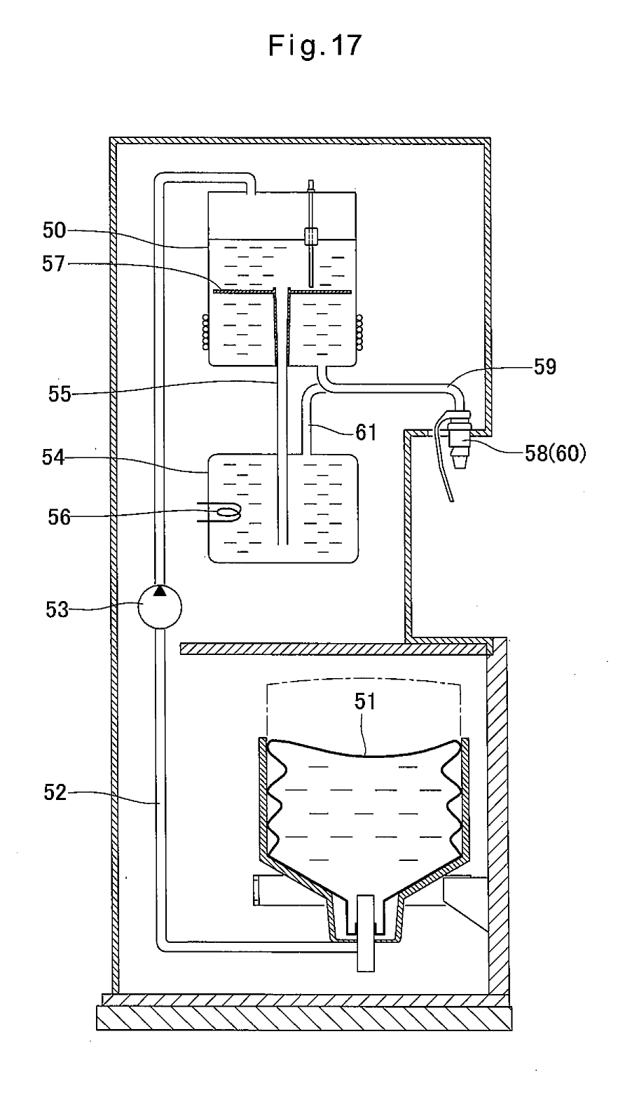

In order to prevent the heater 30 from being turned on with the hot water tank 7 empty when water is fed into the empty hot water tank 7 as shown in FIG. 3, such as when drinking water is introduced into a brand-new water dispenser for the first time, or when drinking water is re-introduced into an existing water dispenser after draining drinking water for maintenance, the control device 41 performs a raw water pump-up step (Step S40 in FIG. 16), alternating with a non-heating circulation step (Step S41).

In particular, when water is fed into the empty hot water tank 7 as shown in FIG. 3, it is necessary to discharge air from the hot water tank 7 by the same amount as the amount of drinking water introduced into the hot water tank 7. If air is not discharged smoothly, drinking water cannot be introduced into the hot water tank 7. That is, even though drinking water is fed into the buffer tank 8, if air is not smoothly discharged from the hot water tank 7, drinking water is slow to move from the buffer tank 8 into the hot water tank 7. This could cause the heater 30 to be turned on and heat the hot water tank 7 while the water level in the hot water tank 7 has not risen to a sufficient height. Once this happens, even after the hot water tank 7 has been filled with drinking water, drinking water may smell and/or taste bad.

In order to avoid this problem, the control device 41 is configured, as described below, to first perform water supply control for supplying water into the cold water tank 2 when the tank 2 is empty, and then perform water supply control for supplying water into the hot water tank 7 when the tank 7 is empty. These controls may be performed immediately before the first water level control after the water dispenser has been switched on.

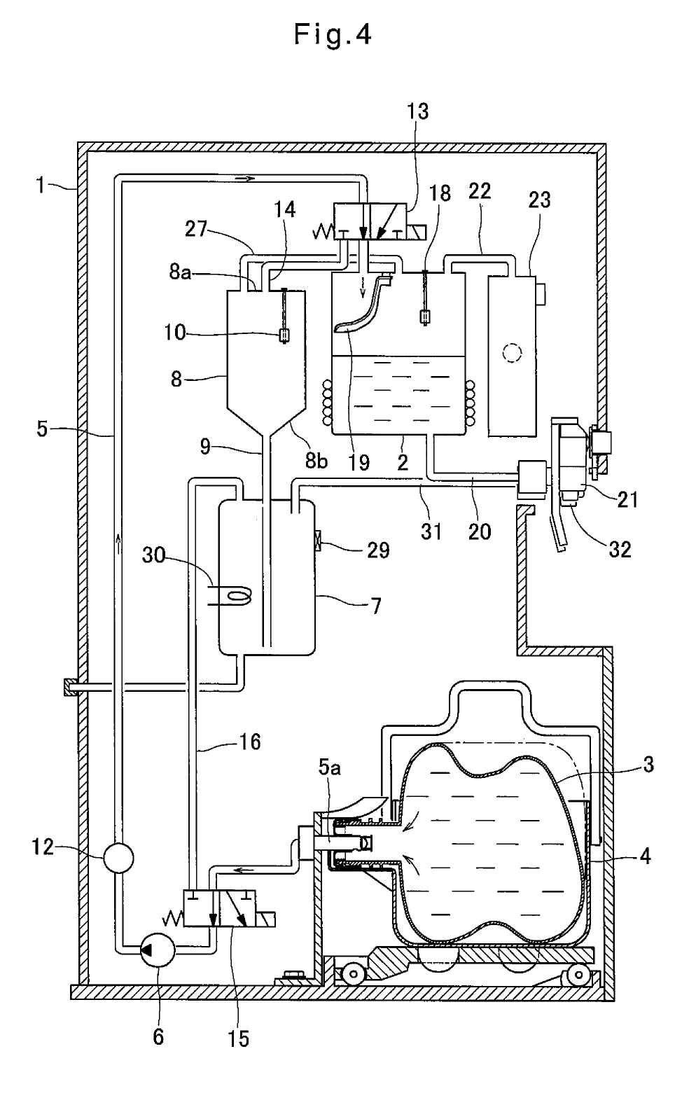

In other words, after the water dispenser has been switched on, the control device 41 first performs the water supply control for supplying water into the empty cold water tank 2. In particular, as shown in FIG. 4, with the first three-way valve 13 in the cold water-side connecting position, and the second three-way valve 15 in the raw water-side connecting position, while keeping the heater 30 off, the control device 41 activates the pump 6 to introduce drinking water in the raw water container 3 into the cold water tank 2. As a result, the water level in the cold water tank 2 rises, and when the water level in the cold water tank 2 reaches the predetermined upper limit, the control device 41 stops the water supply control for supplying water into the empty cold water tank 2, and begins the water supply control for supplying water into the empty hot water tank 7.

During the water supply control for supplying water into the hot water tank 7, the control device 41 performs, as shown in FIG. 16, the raw water pump-up step (Step S40) alternating with the non-heating circulation step (Step S41).

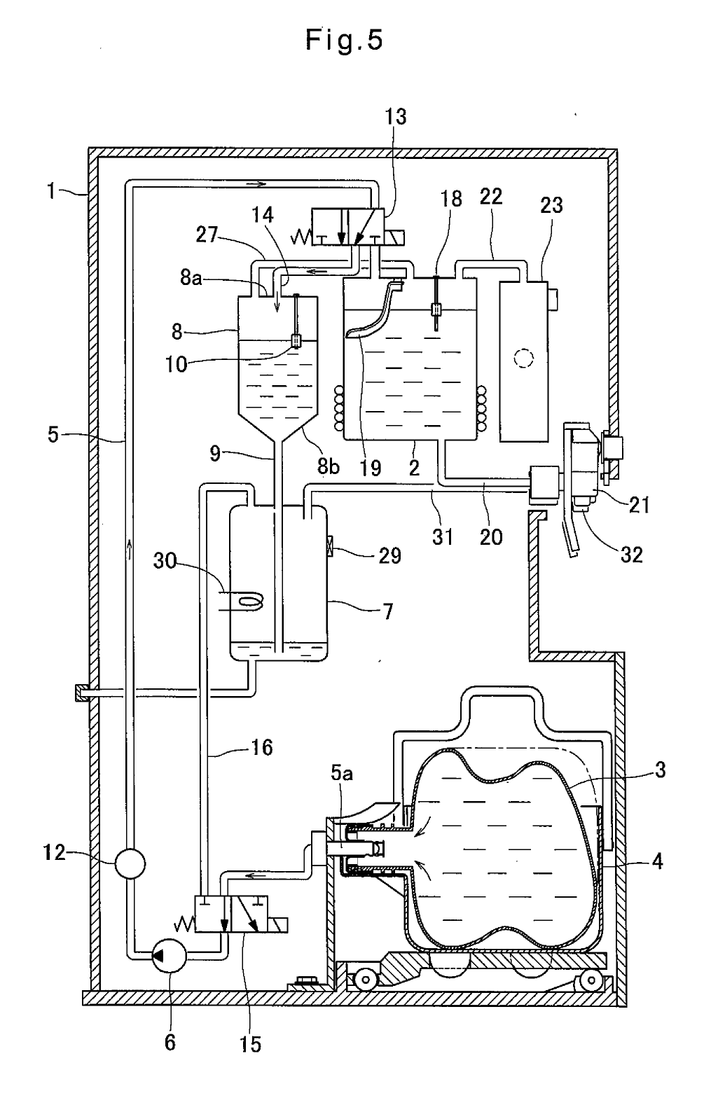

During the raw water pump-up step (Step S40), as shown in FIG. 5, with the first three-way valve 13 in the buffer-side connecting position, and the second three-way valve 15 in the raw-water-side connecting position, while keeping the heater 30 off, the control device 41 activates the pump 6, to introduce drinking water in the raw water container 3 into the buffer tank 8 through the raw water pumping pipe 5, the first three-way valve 13 and the buffer tank supply pipe 14, in this order. As a result, the water level in the buffer tank 8 rises, and when the water level in the buffer tank 8 reaches the predetermined upper limit, the control device 41 deactivates the pump 6 and begins the non-heating circulation step (Step S41).

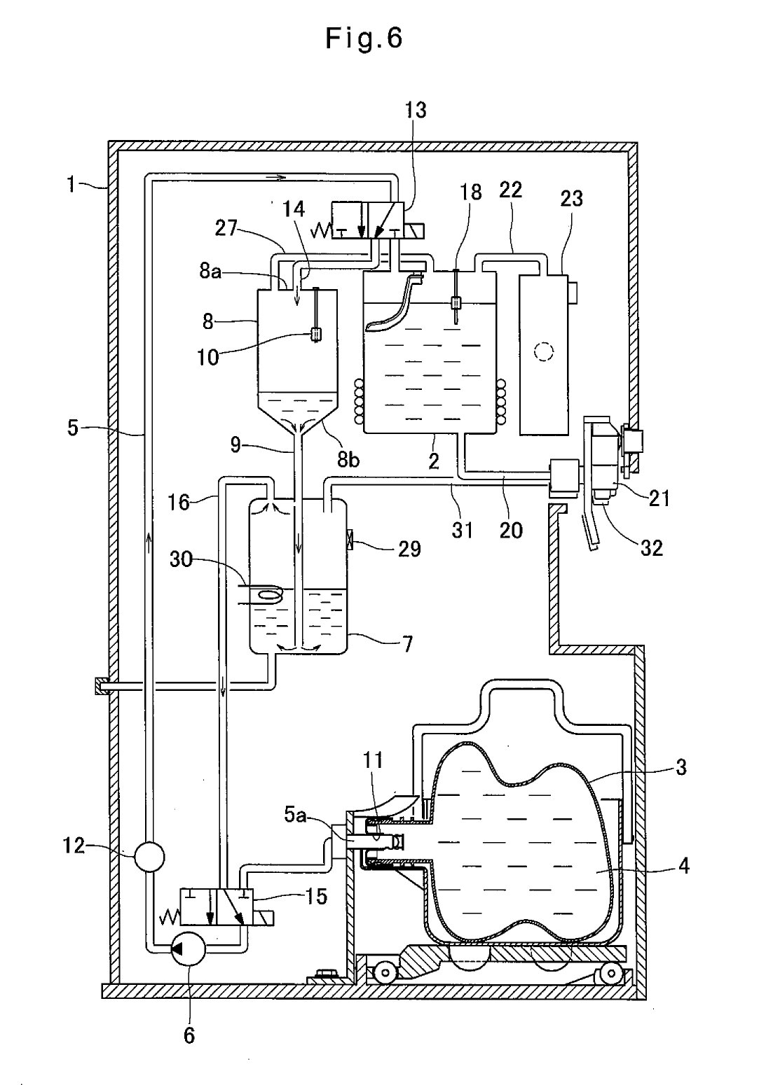

During the non-heating circulation step (Step S41), as shown in FIG. 6, with the first three-way valve 13 in the buffer-side connecting position, and the second three-way valve 15 in the circulation-side connecting position, while keeping the heater 30 off, the control device 41 activates the pump 6 for a predetermined period of time, to discharge air in the upper portion of the interior of the hot water tank 7 through the circulation pipe 16. As a result, at least the same amount of drinking water as the air discharged is moved from the buffer tank 8 into the hot water tank 7.

By performing, in the above-described manner, the raw water pump-up step (Step S40), in which drinking water is pumped up, alternating with the non-heating circulation step (Step S41), in which drinking water is moved from the buffer tank 8 into the hot water tank 7, water can be reliably supplied into the hot water tank 7, which prevents the tank 7 from being heated by the heater 30 with no or insufficient water in the tank 7.

Immediately after every non-heated circulation step (Step S41), the control device 41 determines whether the water level in the buffer tank 8 has reached a predetermined threshold (Step S42), and if this is the case, turns on the heater 30 (Step S43). It is thus possible to automatically turn on the heater 30 only when there is no possibility of the hot water tank 7 being heated by the heater 30 with no or insufficient water in the tank 7.

In the embodiment, the control device 41 is configured to perform the water supply control for supplying water into the cold water tank 2, and then perform the water supply control for supplying water into the hot water tank 7, but may be configured to perform the latter control first instead.

After turning on the heater 30 during the water supply control for supplying water into the hot water tank 7, the control device 41 proceeds to the control during normal operation. By this time, as shown in FIG. 1, water has been introduced into the hot water tank 7, the buffer tank 8 and the cold water tank 2, of the water dispenser.

In this state, as shown in FIG. 7, when the cold water cock 21 is operated, low-temperature drinking water in the cold water tank 2 is discharged by gravity to the outside through the cold water discharge pipe 20. As a result, the amount of drinking water in the cold water tank 2 decreases, and when the water level in the cold water tank 2 as detected by the water level sensor 18 falls below the lower limit, the control device 41 starts the water level control, in which with the first three-way valve 13 in the cold water-side connecting position and the second three-way valve 15 in the raw water-side connecting position, the control device 41 activates the pump 6 to pump up drinking water in the raw water container 3 into the cold water tank 2 through the raw water pumping pipe 5. At this time, since the drinking water introduced into the cold water tank 2 from the raw water pumping pipe 5 is deflected by the guide plate 19 so as to flow in a horizontal direction, cold water accumulated in the lower portion of the interior of the cold water tank 2 is less likely to be stirred by the drinking water introduced into the cold water tank 2. This makes it possible to efficiently cool the drinking water in the cold water tank 2.

As shown in FIG. 8, when the hot water cock 32 is operated, high-temperature drinking water in the hot water tank 7 is discharged to the outside through the hot water discharge pipe 31. Simultaneously, drinking water in the buffer tank 8 is introduced by gravity into the hot water tank 7 through the hot water tank supply pipe 9. At this time, the drinking water in the buffer tank 8 serves to push drinking water in the hot water tank 7 out of the tank 7. When drinking water in the buffer tank 8 is introduced into the hot water tank 7, the water level in the buffer tank 8 falls, so that the control device 41 starts the water level control, in which with the first three-way valve 13 in the buffer-side connecting position and the second three-way valve 15 in the raw water-side connecting position, the control device 41 activates the pump 6 to pump up drinking water in the raw water container 3 into the buffer tank 8.

At this time, drinking water in the raw water container 3, which is at normal temperature, is pumped up directly into the buffer tank 8 without flowing through the cold water tank 2. This prevents normal-temperature drinking water in the raw water container 3 from mixing into the low-temperature drinking water in the cold water tank 2 when discharging drinking water from the hot water tank 7, which in turn makes it possible to effectively keep the drinking water in the cold water tank at low temperature.

When drinking water is introduced into the hot water tank 7 from the buffer tank 8, the temperature of the drinking water in the hot water tank 7 falls. When the temperature in the hot water tank 7, as detected by the temperature sensor 29, falls below the predetermined lower limit set during the heater control (e.g. 85 degrees Celsius), the control device 41. turns on the heater 30 to heat the drinking water in the hot water tank 7.

When the drinking water in the hot water tank 7 is heated by the heater 30, as shown in FIG. 11, air dissolved in the drinking water could separate from the water in the form of air bubbles as the temperature of the drinking water rises, and the air bubbles could rise in the hot water tank 7 and collect at the top portion of the interior of the hot water tank 7, forming an air layer.

In order to prevent the air collected in the hot water tank 7 from blowing out through the hot water tank 7 when a user discharges drinking water in the hot water tank, 7, as described above, the end portion 31a of the hot water discharge pipe 31 on the side of the hot water tank 7 is open at a position spaced downward from the top surface 7a of the hot water tank 7. This arrangement makes it difficult for the air collected along the top surface 7a of the hot water tank 7 to be introduced into the hot water discharge pipe 31.

As shown in FIG. 11, when the amount of air collected in the hot water tank 7 increases to a certain level, air in the hot water tank 7 is discharged through the small hole 34 of the in-tank pipe portion 33 of the hot water tank supply pipe 9. Thus, air will never collect at the portion lower than the small hole 34. Since the small hole 34 is formed at a higher level than the opening of the end portion 31a of the hot water discharge pipe 31, it is possible to effectively prevent air in the hot water tank 7 from being introduced into the hot water discharge pipe 31.

Also, since the end portion 16a of the circulation pipe 16 on the side of the hot water tank 7 is open at a position higher than the small hole 34 of the in-tank pipe portion 33 of the hot water tank supply pipe 9, air collected along the top surface 7a of the hot water tank 7 is discharged from the hot water tank 7 through the circulation pipe 16 during the sterilization operation. This reliably prevents high-temperature air from blowing out through the hot water discharge pipe 31 when a user discharges high-temperature drinking water in the hot water tank 7.

During sterilization operation, as shown in FIG. 2, high-temperature drinking water in the hot water tank 7 is circulated through the circulation pipe 16, second three-way valve 15, raw water pumping pipe 5, first three-way valve 13, buffer tank supply pipe 14, buffer tank 8, and hot water tank supply pipe 9, in this order, to sterilize the circulation path. During sterilization operation, high-temperature drinking water does not flow through the cold water tank 2, so that a user can discharge low-temperature drinking water in the cold water tank 2 even during the sterilization operation.

The initial sterilization operation begins when a user operates the sterilization operation starting button 42. The second and later sterilization operations are automatically carried out at the intervals of one day. The intervals between the sterilization operations are counted by the timer built in the control device 41, which is configured to be started after the initial sterilization operation. The control device 41 may be programmed such that if the sterilization operation starting button 42 is not operated, the sterilization operation may be automatically carried out at the intervals of one day after the water dispenser has been switched on.

Since this water dispenser is arranged such that the communication between the buffer tank 8 and the cold water tank 2 is blocked by the first three-way valve 13, high-temperature drinking water in the hot water tank 7, which communicates with the buffer tank 8, will never flow into the low-temperature drinking water in the cold water tank 2. That is, since the drinking water used to push the drinking water in the hot water tank 7 out of the tank 7 is isolated from the low-temperature drinking water in the cold water tank 2, the drinking water in the cold water tank 2 can be kept at low temperature in a stable and reliable manner. This makes it possible to prevent proliferation of germs in the cold water tank 2.

This water dispenser is further configured such that by activating the pump 6 with the first three-way valve 13 in the buffer-side connecting position and the second three-way valve 15 in the circulation-side connecting position, high-temperature drinking water in the hot water tank 7 can be fed into the raw water pumping pipe 5 and the buffer tank 8, thereby sterilizing the raw water pumping pipe 5 and the buffer tank 8. Further, since the water level control is stopped during the sterilization operation, even when a user discharges low-temperature drinking water in the cold water tank 2 during the sterilization operation, and as a result, the water level in the cold water tank 2 decreases, high-temperature drinking water being circulated through the raw water pumping pipe 5 will never be supplied into the cold water tank 2, so that it is possible to keep drinking water in the cold water tank 2 at low temperature.

Since, as described above, it is possible to keep the drinking water in the cold water tank 2 at low temperature, thereby preventing proliferation of germs in the cold water tank 2, and further, it is possible to sterilize the raw water pumping pipe 5 and the buffer tank 8, which are brought into contact with relatively high-temperature drinking water drawn from the raw water container 3, with high-temperature drinking water, the above-described water dispenser is highly hygienic. Also, since this water dispenser is configured such that when sterilizing the raw water pumping pipe 5 and the buffer tank 8 using the high-temperature drinking water in the hot water tank 7, the high-temperature drinking water never flows through the cold water tank 2, a user can use low-temperature drinking water in the cold water tank 2 even during the sterilizing operation.

### DESCRIPTION OF THE NUMERALS

2. Cold water tank
3. Raw water container
5. Raw water pumping pipe
6. Pump
7. Hot water tank
7a. Top surface
8. Buffer tank
9. Hot water tank supply pipe
13. First three-way valve
14. Buffer tank supply pipe
15. Second three-way valve
16. Circulation pipe
16a. End portion
30. Heater
31. Hot water discharge pipe
31a. End portion
41. Control device

1. A water dispenser comprising:
a cold water tank capable of storing low-temperature drinking water to be discharged to outside;
a replaceable raw water container filled with drinking water to be supplied into the cold water tank;
a raw water pumping pipe through which the raw water container communicates with the cold water tank;
a pump provided at an intermediate portion of the raw water pumping pipe;
a hot water tank capable of storing high-temperature drinking water to be discharged to outside;
a heater capable of heating drinking water in the hot water tank;
a buffer tank disposed above the hot water tank and capable of storing drinking water which is used to push high-temperature drinking water in the hot water tank to outside when discharging the high-temperature drinking water to outside;
a hot water tank supply pipe through which the buffer tank communicates with the hot water tank;
a first three-valve provided at a portion of the raw water pumping pipe between the pump and the cold water tank;
a second three-way valve provided at a portion of the raw water pumping pipe between the pump and the raw water container;
a buffer tank supply pipe through which the first three-way valve communicates with the buffer tank; and
a circulation pipe through which the second three-way valve communicates with the hot water tank,
wherein the first three-way valve is configured to be switchable between a cold water-side connecting position in which the first three-way valve allows communication between the pump and the cold water tank, while blocking communication between the pump and the buffer tank, and a buffer-side connecting position in which the first three-way valve blocks communication between the pump and the cold water tank, while allowing communication between the pump and the buffer tank, and
wherein the second three-way valve is configured to be switchable between a raw water-side connecting position in which the second three-way valve allows communication between the pump and the raw water container, while blocking communication between the pump and the hot water tank, and a circulation-side connecting position in which the second three-way valve blocks communication between the pump and the raw water container, while allowing communication between the pump and the hot water tank.

2. The water dispenser of claim 1, further comprising:
a control device for controlling the first three-way valve, the second three-way valve, the pump and the heater,
wherein the control device is configured, during a normal operation mode, to perform a water level control in which when a water level in the cold water tank falls below a predetermined lower limit, the control device drives the pump with the first three-way valve in the cold water-side connecting position and the second three-way valve in the raw water-side connecting position, and when a water level in the buffer tank falls below a predetermined lower limit, the control device drives the pump with the first three-way valve in the buffer-side connecting position and the second three-way valve in the raw water-side connecting position, and to perform a heater control in which when a temperature in the hot water tank falls below a predetermined lower limit, the control device turns on the heater, thereby increasing the temperature in the hot water tank, and
wherein the control device is further configured, during a sterilization operation mode, to stop the water level control and to perform, simultaneously with the heater control, a water circulation control in which the control device drives the pump with the first three-way valve in the buffer-side connecting position and the second three-way valve in the circulation-side connecting position.

3. The water dispenser of claim 2, wherein during the water circulation control, the control device is configured to deactivate the pump until the temperature in the hot water tank increases to a predetermined high temperature by the heater control, after every time the pump has been continuously driven for a predetermined period of time.

4. The water dispenser of claim 2, wherein the control device is configured to drive the pump such that a revolving speed of the pump when the pump is driven during the sterilization operation mode is lower than a revolving speed of the pump during the normal operation mode.

5. The water dispenser of claim 2, wherein the circulation pipe has on a side of the hot water tank an end portion connected to a top surface of the hot water tank, and
wherein the control device is configured, when supplying water into the hot water tank while the hot water tank is empty, to perform a raw water pump-up step in which the control device drives the pump with the first three-way valve in the buffer-side connecting position and the second three-way valve in the raw water-side connecting position, while keeping the heater off, and to perform, alternating with the raw water pump-up step, a non-heating circulation step in which the control device drives the pump with the first three-way valve in the buffer-side connecting position and the second three-way valve in the circulation-side connecting position, while keeping the heater off.

6. The water dispenser of claim 5, wherein the control device is configured to turn on the heater if the control device determines that a water level in the buffer tank immediately after the non-heating circulation step is equal to or higher than a predetermined threshold value.

7. The water dispenser of claim 1, further comprising a hot water discharge pipe through which high-temperature drinking water in the hot water tank can be discharged to outside, and which includes an end portion (31a) on a side of the hot water tank, wherein the circulation pipe has on a side of the hot water tank an end portion connected to a top surface of the hot water tank, wherein the end portion of the hot water discharge pipe has an opening spaced downwardly from the top surface of the hot water tank, wherein the end portion of the circulation pipe has an opening located at a higher level than the opening of the end portion of the hot water discharge pipe.
